(19) United States
(12) Patent Application Publication
(10) Pub. No.: US 2012/0126634 A1
(43) Pub. Date: May 24, 2012

(54) LIGHT-CONTROLLED POWER APPARATUS

(76) Inventor: Jui-Hsiung Wu, Taipei (TW)

(21) Appl. No.: 12/952,189

(22) Filed: Nov. 22, 2010

(51) Int. Cl. H01H 47/24

(52) U.S. Cl. 307/117

(57) ABSTRACT

A light-controlled power apparatus includes an insulating housing, a plurality of conductive terminals and a light-controlled circuit. The conductive terminals are disposed in the insulating housing and partially stretch out of the insulating housing for connecting with an AC power supply. The light-controlled circuit is disposed in the insulating housing and includes a power module, a control module and a switch module having a relay and a driving circuit. The power module is connected with the conductive terminals for getting and dealing with an AC input voltage to output an output voltage. The control module includes a light-detecting unit for detecting environment illumination intensity and then sending out a corresponding first signal, a light-detecting power unit for regulating the output voltage and then providing a work voltage for the light-detecting unit, and a switch control circuit unit capable of getting a second signal reflecting standard illumination intensity.

### BACKGROUND OF THE INVENTION

1. Field of the Invention

The present invention generally relates to a power apparatus, and more particularly to a light-controlled power apparatus.

2. The Related Art

A power apparatus of a common electric appliance includes an insulating housing and a plurality of electrical contacts disposed in the insulating housing. When the electric appliance is in use, the electrical contacts of the power apparatus are connected with a power supply to make the power supply provide power for the electric appliance. When the electric appliance is not in use, the electrical contacts of the power apparatus can be withdrawn from the power supply or the switch of the power supply can be turned off.

However, if the power apparatus is always connected with the power supply with the switch of the power supply not yet switched off after the electric appliance is not in use, then a circuit may always be formed to continually consume a current so that results in waste of power. In addition, the electric appliance may be subjected to sustain high temperature due to long-term use. As a result, the electric appliance is apt to be damaged. So the users often need to pull out the power apparatus from the power supply or switch off the switch of the power supply, when not making use of the electric apparatus. It is inconvenient to use. So a power apparatus having a light-controlled function is required.

### SUMMARY OF THE INVENTION

An object of the present invention is to provide a light-controlled power apparatus. The light-controlled power apparatus includes an insulating housing, a plurality of conductive terminals and a light-controlled circuit. The conductive terminals are disposed in the insulating housing and partially stretch out of the insulating housing for connecting with an AC power supply. The light-controlled circuit is disposed in the insulating housing and includes a power module, a control module and a switch module. The power module is connected with the conductive terminals for getting and dealing with an AC input voltage to output a proper output voltage. The control module includes a light-detecting unit exposed out of the insulating housing for detecting environment illumination intensity under which an external electric appliance works and then sending out a corresponding first signal, a light-detecting power unit for regulating the output voltage of the power module and then providing a work voltage for the light-detecting unit, and a switch control circuit unit capable of getting a second signal reflecting standard illumination intensity. The switch control circuit unit deals with the first signal and the second signal by means of comparing the environment illumination intensity with the standard illumination intensity and then sends out corresponding control signals. The switch module has a relay and a driving circuit. The driving circuit controls switch statuses of the relay according to the control signals from the control module, so as to further control whether the AC power supply outputs power to the external electric appliance or not. The switch statuses of the relay rest with whether the output voltage of the power module is provided thereon or not under the control of the driving circuit.

As described above, the light-controlled power apparatus of the present invention drives the driving circuit to control the switch states of the relay and further control whether there is power provided for the external electric appliance or not, by means of utilizing the light-detecting unit to detect the environment illumination intensity, and then utilizing a second comparator to receive and deal with the environment illumination intensity and the standard illumination intensity so as to output corresponding control signals to the driving circuit. Therefore, even if users forget to switch off switches of the AC power supply by hand, the light-controlled power apparatus of the present invention still can avoid waste of power or damage of the electric appliances due to long-term use.

### BRIEF DESCRIPTION OF THE DRAWINGS

The present invention will be apparent to those skilled in the art by reading the following description, with reference to the attached drawings, in which:

FIG. 1 is a perspective view of an embodiment of a light-controlled power apparatus according to the present invention;

FIG. 2 is a block diagram of a light-controlled circuit of the light-controlled power apparatus of FIG. 1; and

FIG. 3 is a circuitry of the light-controlled circuit of FIG. 2.

### DETAILED DESCRIPTION OF THE PREFERRED EMBODIMENT

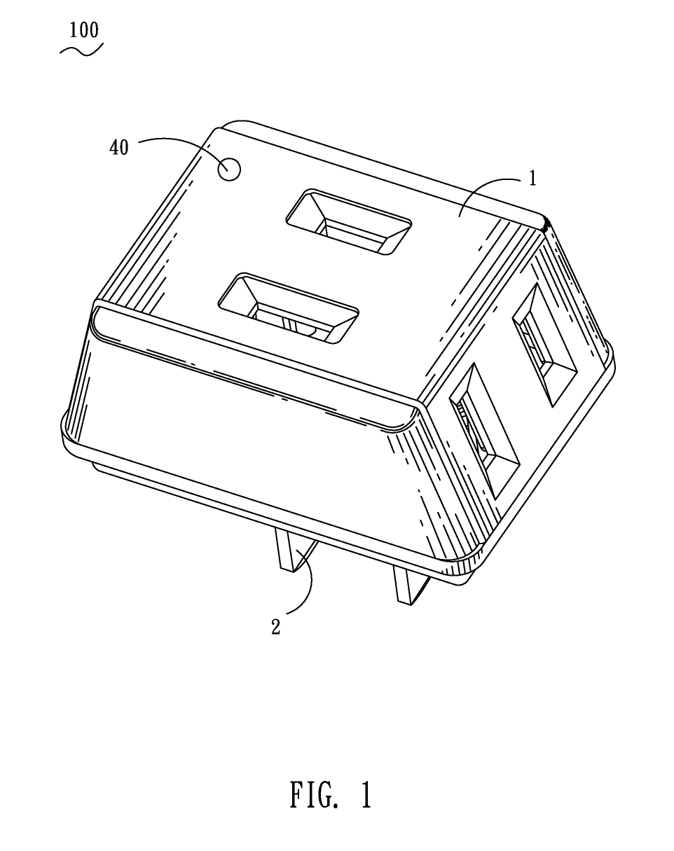

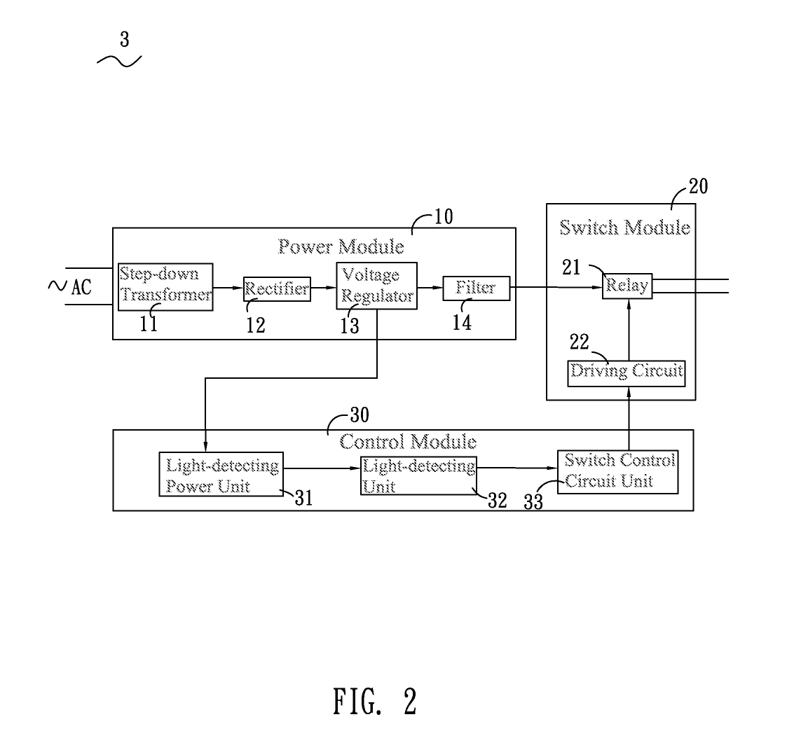

With reference to FIG. 1 and FIG. 2, a light-controlled power apparatus 100 according to an embodiment of the present invention includes an insulating housing 1, a plurality of conductive terminals 2 and a light-controlled circuit 3. In this embodiment, the insulating housing 1 is an ordinary receptacle housing. A top of the insulating housing 1 defines a through hole 40. The conductive terminals 2 are disposed in the insulating housing 1 and partially stretch out of a bottom of the insulating housing 1 for connecting with an AC power supply. The light-controlled circuit 3 is assembled in the insulating housing 1.

Referring to FIG. 2, the light-controlled circuit 3 includes a power module 10, a switch module 20 and a control module 30.

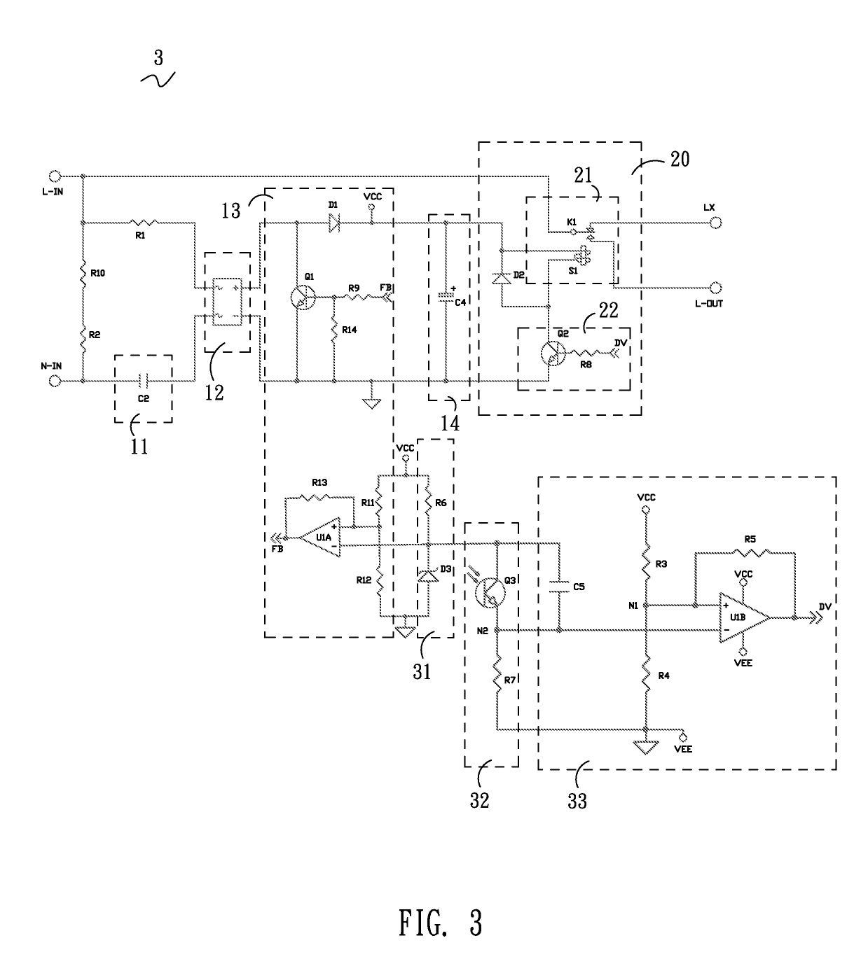

Referring to FIG. 2 and FIG. 3, the power module 10 is electrically connected with the conductive terminals 2 for getting an AC input voltage. The power module 10 includes a step-down transformer 11, a rectifier 12, a voltage regulator 13 and a filter 14 which are successively connected together. The step-down transformer 11 has a capacitor C2 for achieving a step-down function to the AC input voltage. The rectifier 12, connected with the step-down transformer 11, is for transforming the step-down voltage to a DC voltage. The voltage regulator 13 for regulating the DC voltage has a first comparator U1A and a first transistor Q1 of which the collector and the emitter are respectively connected to positive and negative output ports of the rectifier 12. The negative output port of the rectifier 12 is further connected to ground. The filter 14 is connected with the voltage regulator 13 for filtering out undesired signals. The non-inverting input of the first comparator U1A is connected between two terminals of a first voltage-dividing resistor R11 and a second voltage-dividing resistor R12 connected in series. The other two terminals of the first and the second voltage-dividing resistors (R11, R12) are respectively connected to a positive output terminal VCC of the power module 10 and ground. The inverting input of the first comparator U1A is connected with a standard voltage which will be defined later. The output of the first comparator U1A is connected with the base of the first transistor Q1 so as to control switch statuses of the first transistor Q1 according to a voltage comparison result of the non-inverting input with the inverting input.

When the non-inverting input is at a higher voltage than the inverting input, namely a potential between the first voltage-dividing resistor R11 and the second voltage-dividing resistor R12 after an output voltage of the positive output terminal VCC is divided by the first and the second voltage-dividing resistors (R11, R12) is higher than the standard voltage, the output of the first comparator U1A outputs a positive voltage signal to control the first transistor Q1 connected. At this time, the positive output port of the rectifier 12 is short connected to ground, and the power module 10 has no voltage output. When the non-inverting input is at a lower voltage than the inverting input, namely the potential between the first voltage-dividing resistor R11 and the second voltage-dividing resistor R12 after the output voltage of the positive output terminal VCC is divided by the first and the second voltage-dividing resistors (R11, R12) is lower than the standard voltage, the output of the first comparator U1A outputs a negative voltage signal to control the first transistor Q1 disconnected. At this time, the power module 10 has a normal voltage output.

Referring to FIG. 2 and FIG. 3, the switch module 20 includes a relay 21 and a driving circuit 22. The driving circuit 22 has a second transistor Q2 of which the collector is connected to the positive output terminal VCC of the power module 10 through a directive diode D2, the emitter is connected to ground and the base is connected with the control module 30. The relay 21 is composed of a control system Si parallel-connected to the directive diode D2, and a switch system K1 of which the stationary contact is connected with one of the conductive terminals 2, and one movable contact is drawn forth as an output for connecting with an external electric appliance, wherein switch statuses of the switch system K1 are controlled according to whether the output voltage of the power module 10 is output on the control system S1 or not, so as to further control whether there is power provided for the external electric appliance or not.

Referring to FIG. 2 and FIG. 3, the control module 30 includes a light-detecting power unit 31, a light-detecting unit 32 and a switch control circuit unit 33. The light-detecting power unit 31 is electrically connected between the power module 10 and the light-detecting unit 32, for regulating the output voltage of the power module 10 so as to provide a work voltage for the light-detecting unit 32. The work voltage is no other than the above mentioned standard voltage. The light-detecting power unit 31 includes a third voltage-dividing resistor R6 and a voltage-regulating diode D3 of which the cathode is connected to the positive output terminal VCC of the power module 10 via the third voltage-dividing resistor R6 and the anode is connected to ground. The inverting input of the first comparator U1A is connected with the cathode of the voltage-regulating diode D3.

Referring to FIGS. 1-3, the light-detecting unit 32 is used to receive light signals and then transform the light signals into electric signals. The light-detecting unit 32 has a photosensitive transistor Q3 exposed out from the through hole 40 of the insulating housing 1 for detecting environment illumination intensity under which the external electric appliance works and then sending out a corresponding first signal N2. The collector of the photosensitive transistor Q3 is connected with the cathode of the voltage-regulating diode D3. The emitter of the photosensitive transistor Q3 is connected to ground via a resistor R7. The switch control circuit unit 33 is connected with the light-detecting unit 32 to receive the electric signals therefrom and then amplify the electric signals by means of a second comparator U1B. In this embodiment, the second comparator U1B is an operational amplifier. The non-inverting input of the second comparator U1B is connected between a fifth voltage-dividing resistor R3 and a fourth voltage-dividing resistor R4 connected in series to receive a second signal N1 which reflects standard illumination intensity. The other two terminals of the fifth and the fourth voltage-dividing resistors (R3, R4) are respectively connected to the positive output terminal VCC of the power module 10 and ground. The inverting input of the second comparator U1B is connected with the emitter of the photosensitive transistor Q3 to receive a first signal N2 which reflects environment illumination intensity. The output of the second comparator U1B is connected with the base of the second transistor Q2 so as to control switch statuses of the second transistor Q2 by means of the second comparator U1B dealing with the second signal N1 and the first signal N2, namely comparing the standard illumination intensity with the environment illumination intensity.

Referring to FIGS. 1-3, when the environment illumination intensity is lower than the standard illumination intensity, the photosensitive transistor Q3 has a great resistance. The second comparator U1B transmits a control signal to the driving circuit 22, and the second transistor Q2 is connected. After the second transistor Q2 is connected, the output voltage of the power module 10 is provided on the control system S1 of the relay 21. Therefore, the switch system K1 is closed, and there is power provided for the external electric appliance. When the environment illumination intensity is higher than the standard illumination intensity, the resistance of the photosensitive transistor Q3 gradually becomes small. The second comparator U1B transmits another control signal to the driving circuit 22, and the second transistor Q2 is disconnected. As a result, the switch system K1 is opened due to the status of no voltage on the control system S1. So the electric appliance is shut off automatically on account of no power thereon.

As described above, the light-controlled power apparatus 100 of the present invention drives the driving circuit 22 to control the switch states of the relay 21 and further control whether there is power provided for the external electric appliance or not, by means of utilizing the light-detecting unit 32 to detect the environment illumination intensity, and then utilizing the second comparator U1B to receive and deal with the environment illumination intensity and the standard illumination intensity so as to output corresponding control signals to the driving circuit 22. Therefore, even if users forget to switch off switches of the AC power supply by hand, the light-controlled power apparatus 100 of the present invention still can avoid waste of power or damage of the electric appliances due to long-term use.

The foregoing description of the present invention has been presented for purposes of illustration and description. It is not intended to be exhaustive or to limit the invention to the precise form disclosed, and obviously many modifications and variations are possible in light of the above teaching. For example, the insulating housing 1 can be an ordinary plug housing, a socket housing or a power adapter housing. Such modifications and variations that may be apparent to those skilled in the art are intended to be included within the scope of this invention as defined by the accompanying claims.

What is claimed is:

1. A light-controlled power apparatus, comprising:
an insulating housing;
a plurality of conductive terminals disposed in the insulating housing and partially stretching out of the insulating housing for connecting with an AC power supply; and
a light-controlled circuit disposed in the insulating housing and including:
a power module connected with the conductive terminals for getting and dealing with an AC input voltage to output a proper output voltage;
a control module including a light-detecting unit exposed out of the insulating housing for detecting environment illumination intensity under which an external electric appliance works and then sending out a corresponding first signal, a light-detecting power unit for regulating the output voltage of the power module and then providing a work voltage for the light-detecting unit, and a switch control circuit unit capable of getting a second signal reflecting standard illumination intensity, wherein the switch control circuit unit deals with the first signal and the second signal by means of comparing the environment illumination intensity with the standard illumination intensity and then sends out corresponding control signals; and
a switch module having a relay and a driving circuit, the driving circuit controlling switch statuses of the relay according to the control signals from the control module, so as to further control whether the AC power supply outputs power to the external electric appliance or not, wherein the switch statuses of the relay rest with whether the output voltage of the power module is provided thereon or not under the control of the driving circuit.

2. The light-controlled power apparatus as claimed in claim 1, wherein the light-detecting power unit includes a voltage-dividing resistor and a voltage-regulating diode of which the cathode is connected to a positive output terminal of the power module via the voltage-dividing resistor and the anode is connected to ground, the connection of the voltage-dividing resistor and the voltage-regulating diode is drawn forth to be connected with the light-detecting unit to provide the work voltage for the light-detecting unit.

3. The light-controlled power apparatus as claimed in claim 1, wherein the insulating housing defines a through hole therein, the light-detecting unit has a photosensitive transistor exposed out from the through hole of the insulating housing, the collector of the photosensitive transistor is connected with the power module and the emitter thereof is connected to ground via a resistor, the emitter of the photosensitive transistor is further connected with the switch control circuit unit for transmitting the first signal to the switch control circuit unit.

4. The light-controlled power apparatus as claimed in claim 1, wherein the switch control circuit unit has a comparator of which the non-inverting input is connected between two voltage-dividing resistors connected in series for getting the second signal, another two terminals of the two voltage-dividing resistors are respectively connected with a positive output terminal of the power module and ground, the inverting input of the comparator is connected with the light-detecting unit to receive the first signal, the output of the comparator is connected with the driving circuit to send the control signals thereto.

5. The light-controlled power apparatus as claimed in claim 4, wherein the comparator is an operational amplifier.

6. The light-controlled power apparatus as claimed in claim 1, wherein the driving circuit has a transistor of which the collector is connected to a positive output terminal of the power module via a directive diode, the emitter is connected to ground and the base is connected with the switch control circuit unit, the relay comprises a control system parallel-connected to the directive diode, and a switch system connected between one of the conductive terminals and the external electric appliance.

7. The light-controlled power apparatus as claimed in claim 1, wherein the power module includes a step-down transformer, a rectifier, a voltage regulator and a filter which are successively connected together.

8. The light-controlled power apparatus as claimed in claim 1, wherein the insulating housing is a plug housing, a socket housing, a connector housing or a power adapter housing.
